(19) United States
(12) Patent Application Publication
(10) Pub. No.: US 2013/0124515 A1
(43) Pub. Date: May 16, 2013

(54) METHOD FOR DOCUMENT SEARCH AND ANALYSIS

(71) Applicant: Shankar Ghimire, Fairfax, VA (US)

(72) Inventor: Shankar Ghimire, Fairfax, VA (US)

(73) Assignee: FOUNDATIONIP LLC, Minneapolis, MN (US)

(21) Appl. No.: 13/811,885

(22) PCT Filed: Jul. 26, 2011
(86) PCT No.: PCT/US2011/045263

§ 371 Date: Jan. 23, 2013

Related U.S. Application Data
(60) Provisional application No. 61/366,937, filed on Jul. 23, 2010.
(60) Provisional application No. 61/367,453, filed on Jul. 26, 2010.

(51) Int. Cl. G06F 17/30; G06F 17/21

(52) U.S. Cl. CPC G06F 17/30554; G06F 17/212
USPC 707/728; 715/273

(57) ABSTRACT

A search platform and method for enhancing analysis of contents in a patent/non-patent literature document by locating/extracting additional similar contents in the patent/non-patent literature document based on a user selected content/text in the document. A user selects a first portion of the text in the patent/non-patent literature document, and in response to the user selection of the first portion of the text, the search engine automatically highlights at least a second portion of the text in the same patent/non-patent literature document wherein the first portion and the second portion of the text have closest similar contents compared to the rest of the patent/non-patent literature document.

### CROSS REFERENCE TO RELATED APPLICATIONS

This application claims priority to U.S. Provisional Patent Application No. 61/366937 filed on Jul. 23, 2010 and U.S. Provisional Patent Application No. 61/367453 filed on Jul. 26, 2010, which are incorporated herein in their entirety by reference.

### FIELD OF THE DISCLOSURE

The disclosure of the present application relates to searching documents, including a search platform that can search for and correlate elements in written and drawing or graphical portions of a document or across multiple documents.

### BACKGROUND

The growth of computing and information technology has enabled a user to easily access information stored within a large number of documents at different locations such as the computer's local hard drive or a remote web server on the Internet. But quickly locating the information sought by the user within a document remains a challenge.

Several search engines are developed that are geared toward locating relevant patent documents for a researcher. After location of a patent document, the user still needs to analyze the document to determine its relevancy. Location of the relevant content in a document by means of a user selected keyword is not always efficient, when the searcher needs to thoroughly evaluate a patent in a short time. The patent research process can be made more efficient, if there is provided a method that can locate various portions of the document having similar content in the same patent document.

The manner in which documents can describe subject matter is widely varied. In some situations, a document can describe one or more elements of a particular subject matter in different portions of the document, with each portion reflecting a distinct manner of presentation. For example, many patent documents (e.g., patents and published patent applications) include a written portion (referred to as a specification) and a drawing portion (referred to as drawings), and generally describe one or more elements in both their written portion and their drawing portion. The patent documents generally reference each element by an identifier, such as a numeral for example.

Patent applications submitted for examination before the Patent and Trademark Office must meet certain requirements in order to issue as patents. For example, the subject matter claimed in the patent applications must be deemed new, useful, and non-obvious in the United States or be deemed useful with an inventive step in European offices. Similar standards are applied in patent offices around the world. To more effectively prepare a patent application for examination, it is useful to have knowledge of prior technical and patent documents in the same and related areas of technology. Conducting a patent search can be one way in which such “prior art” can be ascertained. The results of the patent search can help the drafter of a patent application focus on aspects that appear to be patentable subject matter and aid in developing a reasonable strategy for achieving the goals of the inventor or owner of the patent rights.

Prior to the evolution of technology in the current electronic information age, patent searches were conducted manually. A searcher would review a patent disclosure and conduct a paper search based upon a patent classification system. With the advent of information technology, paper search has given way to electronic search since most patents and published patent applications are available in electronic form. Unfortunately, although electronic search tools can provide search results much faster than a paper search, the tools provide minimal support in helping the patent searcher quickly and efficiently review and analyze the provided information.

In other industries, the search and display of information in text and graphical form can be highly useful in a variety of ways. Other applications such as technical and medical journals and books, magazines, advertisements, marketing materials, web sites, maps and charts, architectural or engineering papers and drawings, and instruction manuals use a combination of graphics and text to display information.

Several search engines are developed that are geared toward locating relevant legal, patent, or non-patent technical documents for a researcher. After location of a document, the user still needs to analyze the document to determine its relevancy. Location of the relevant content in a document by means of a user selected keyword is not always efficient, when the searcher needs to thoroughly evaluate a patent in a short time. What is needed is to make the document research process more efficient, if there is provided a method that can locate various portions of the document having similar content in the same patent document.

### SUMMARY

The invention relates generally to a technique for facilitating document review, and in particular to a technique for facilitating document review in an efficient manner by automatically identifying similar contents within the document.

In an embodiment, the portion of the text in a patent/non-patent literature include a paragraph, or a sentence, or a phrase, or a portion of a paragraph, or a portion of a sentence. In another preferred embodiment, in response to the user selection of the first portion, the search engine automatically highlights both the first portion and the second portion with the same color or with a user preferred color scheme.

In another preferred embodiment, the first portion includes highlighted keywords used by the searcher for the purpose of searching. In another preferred embodiment, the system automatically decides the first portion based on the involvement of the keywords and their proximity relationship in the first portion and automatically highlights the second portion having a closest similar content with the first portion. In yet another preferred embodiment, in response to the user selection of a first portion, the system automatically identifies a plurality of keywords from the selected portion and populates the identified keywords in a pop-up window. The user can select a multiple of the identified keywords from the pop-up window to allow the system to automatically highlight the second portion having a closest similar content with the first portion.

### BRIEF DESCRIPTION OF THE DRAWINGS

For a better understanding of the nature of the present invention, its features and advantages, the subsequent detailed description is presented in connection with accompanying drawings in which:

FIG. 1 illustrates an example of a search platform architecture capable of implementing the invention;

FIG. 2 illustrates an example of a process for identifying text in a written portion or drawing of a document;

FIG. 3 illustrates describes GUI layout of keyword sets and highlighted part of the paragraph based on user selection of a keyword set. The keyword strings corresponding to the selected keyword set are displayed at the top of the layout;

FIGS. 4 and 5 illustrate varying embodiments with the user switching to a new keywords set. User can easily switch to new keyword set by clicking a button.

FIG. 6. illustrates an embodiment with paragraphs having minimize buttons. FIG. 6 also displays additional keywords extracted/detected by the system. The user can select these keywords set for highlighting purpose or can send to one of a categorized keyword set which are representative of a particular feature of the search.

FIG. 7 illustrates a GUI layout wherein a user can mouse select a text word (keyword) and upon the selection, a drop down menu will appear which will let the user to send the selected keyword into the keyword highlighting box or allows the user to directly highlight the keyword in the whole document.

FIG. 8 illustrates a GUI layout wherein the user selected keywords and detected keywords are separately presented in different boxes for user convenience.

FIG. 9 describes a similar GUI layout wherein a Keyword set (representative of a feature) has been expanded to show the color spectrum of the keywords (and synonyms). A user can add new keyword or save as new keyword set as needed.

FIG. 10 describes a GUI layout wherein a user selects a Similarity Excitation Button adjacent to a paragraph which leads to highlighting of the relevant paragraphs in a user selected color scheme. In another embodiment, the paragraphs can be ranked for relevancy.

FIG. 11 describes another similar GUI layout as in FIG. 10 with additional Similarity Excitation Button. A user can use the Similarity Excitation Button or select a portion of the text in the document to automatically locate the most relevant paragraph/portion of the text.

FIG. 12 illustrates an exemplary GUI layout wherein in response to a user selection of a paragraph (or a user selection of a portion of a text) the program code of the inventive system can locate most relevant paragraph (to the selected portion of the text).

FIG. 13 illustrates a particular scenario as described in preferred embodiment 12.

### DETAILED DESCRIPTION

The present disclosure is directed to a search platform that can search for and correlate elements in written and drawing portions of a document. By locating and correlating elements in written and drawing portions of a document, the search platform can enable users to quickly and efficiently review and analyze the elements in the context of the document.

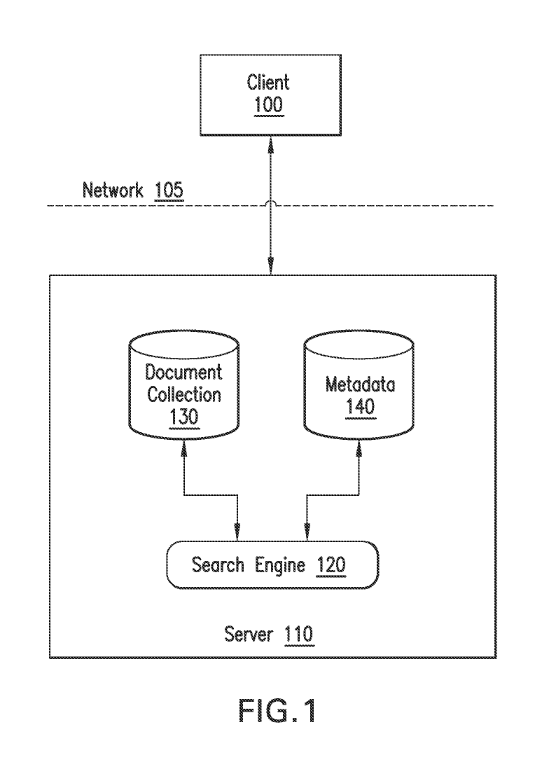

FIG. 1 illustrates an embodiment of a search platform architecture in accordance with the present disclosure. In the illustrated embodiment, a user operating client 100 can access server 110 across network 105. Server 110 can deploy search engine 120, which can be associated with document collection 130 and, in some embodiments, metadata 140. The computer system executing above functions includes a central processing unit (CPU), a memory, a bus, and input/output (I/O) interfaces and external devices. The external devices can comprise any devices (e.g., keyboard, pointing device, display, etc.) that enable a user to interact with computer system and/or any devices (e.g., network card, modem, etc.) that enable computer system to communicate with one or more other computing devices. The computer system is in communication with external I/O devices/resources and storage system. In general, the processing unit executes computer program code, such as the code to implement various components of the process and system for enabling a search engine user in parsing and analyzing the user inputted strings to provide the search results and layout described above. While executing computer program code, the processing unit can read and/or write data to/from the memory, the storage system, and/or the I/O interfaces. The “program code” may include code or notation, of a set of instructions intended to cause a computing device having an information processing capability to perform a particular function described above by changing to another form (language, code or notation).

Document collection 130 can include one or more databases storing documents. The documents can have different portions directed to representing information in different manners, such as a written portion (comprising text, paragraphs, headings, symbols, code, etc.) and a drawing portion (comprising images, illustrations, charts, graphics, maps, photos, diagrams, tables, etc.) or could be separate documents linking the written and drawing portions together by some type of reference or indicator. Exemplary documents held within the document database(s) includes documents that contains at least one figure, drawing, graphic, symbol, map, photo, diagram, charts, etc, (“drawing”) that have or could have explanatory text that is directed towards a portion of the drawing and somehow indicated in its corresponding location in the drawing and text. Exemplary documents can further comprise technical or medical journals, books, or papers, legal documents and opinions, magazines, advertisements, marketing documents, photographs, web pages, maps, architectural drawings, engineering drawings, process and operation manuals, and software manuals. In other embodiments, the documents can comprise legal documents, such as patents and/or patent publications for example, associated with one or more national patent office. Metadata 140 can include one or more databases storing data associated with the documents, such as a list of elements associated with each document and a list of locations in the each portion of each document associated with the elements for example. In one embodiment, the elements can correspond to subject matter of patent documents that is associated with a reference identifier such as a numeral or alphanumeric character(s).

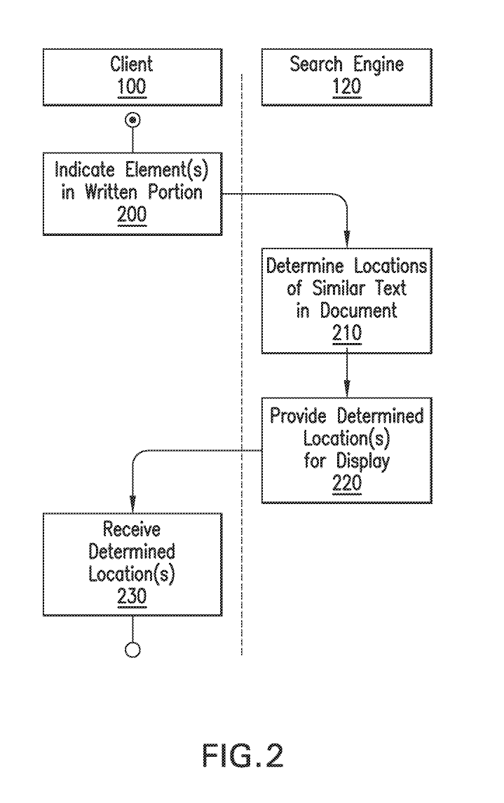

A method for enhancing analysis of contents in a patent or non-patent literature document is implemented by locating or extracting additional similar contents in the patent/non-patent literature document based on a user selected content or text in the document. The ways in which search engine 120 can search for and identify similar text located in different portions of a document can be widely varied. In some embodiments, as illustrated in FIG. 2, search engine 120 can identify the location of similar text in the second portion of the document based on an indication of the text of interest to a user in a first portion of a document. In other embodiments, search engine 120 can identify the location of elements in portions of a document based on an indication of the element by a user in a search request.

In the embodiment illustrated in FIG. 2, client 100 can provide (block 200) an indication of one or more words or paragraphs associated with a written portion of a document to search engine 120. The indication can be provided by client 100 in any suitable manner. For example, in one embodiment the element can comprise text followed by a reference identifier, and the indication of the element can be provided by the selection or rolling over of the text and/or reference identifier with a selection mechanism that could include a mouse, a pointing device, keyboard strokes, stylus pen, etc., when displayed to client 100 in the written portion of the document.

In response to the indication, search engine 120 can determine (block 210) the one or more locations of the indicated text in the textual or drawing portion of the document or of a second document. The manner in which the location can be determined can be widely varied. In one embodiment, for example, search engine 120 can determine the one or more locations on the spot by forming document vectors from the indicated portion of the document. In other embodiments, optical recognition can seek the text and/or reference identifiers within drawings similar to the indicated text, for example. Further, metadata or other types of tags could be associated with textual or drawing indications and be used to search a corresponding database linked to the tag. In other examples, patterns, shades, colors, or other graphical devices could be used to identify textual and drawing elements.

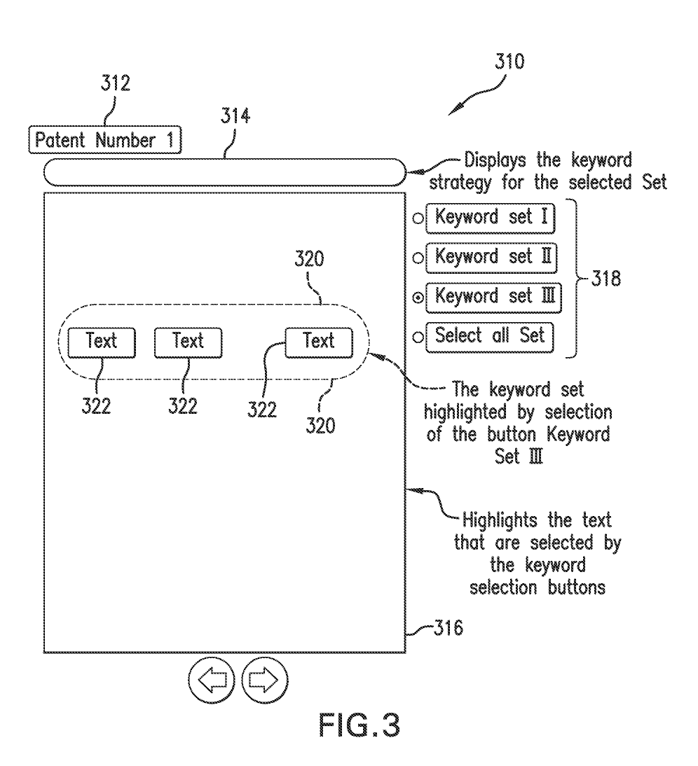

Referring to FIG. 3, a graphical user interface (“GUI”) 310 layout is illustrated. A document name or identifier of interest is shown as “Patent Number 1” in window 312. A keyword or keyword sets 322 are identified in a portion of the document. In an embodiment, a user selects a first portion of the text 320 in the patent/non-patent literature document and selects or highlights part of the paragraph based on user selection of a keyword set. The keyword strings 322 corresponding to the selected keyword set are displayed at the top of the layout 314. The user then assigns the keyword selection to a keyword set that is linked to menu 318. Multiple sets of keywords 320 and paragraph selections 320 can be assigned to multiple menus 318 with identification numbers such as set one, set two, etc. A selection of one of the keyword sets 318 highlights the keywords 322 and text or graphics 320 associated with the keyword set 318. A set of keywords 318 represent a particular feature of the search. In an embodiment, the selection of the keywords 318 can be performed by means of buttons 324 where the selection of buttons 324 highlight a particular set of keywords 322 that represent a particular feature of the search. By clicking a button 324 among a multiple buttons 318 a user can switch highlighting from a first set of keywords to second set of keywords instantly. In another embodiment, more than one button 324 can be selected to highlight more than one set of keywords 322 and text 320.

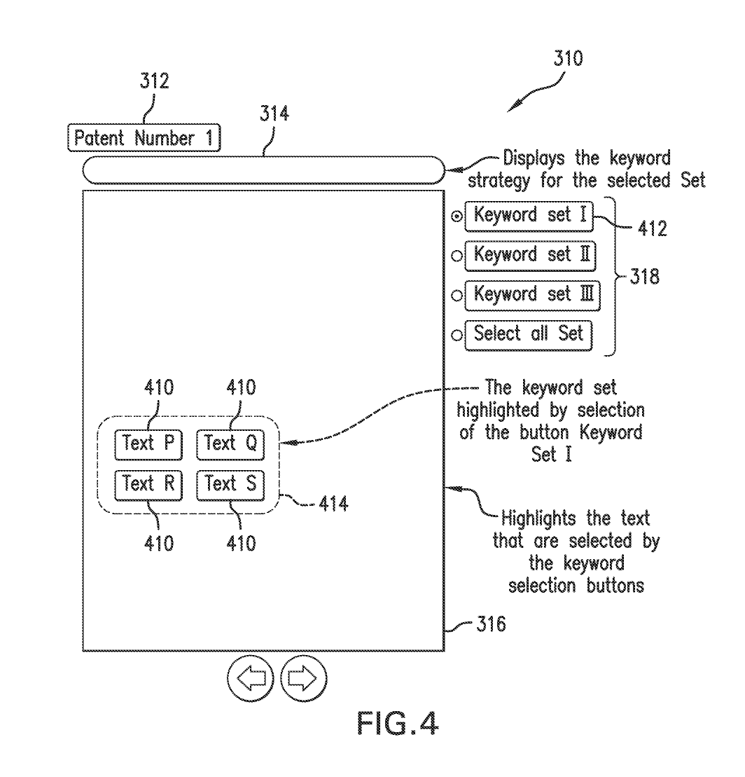

FIG. 4 illustrates the GUI interface 310 of FIG. 3 with a set of four exemplary keywords 410 that are linked to Keyword Set One 412 and highlighted when Set One 412 is selected using a radio button. Text portions 414 of displayed document 316 near to keywords 410 are also highlighted when Keyword Set One 412 option is displayed. FIG. 5 illustrates a similar embodiment as that shown in FIG. 4. Keywords 410 have been defined by a user as the Keyword Set Three 512. When Set Three 512 of the keyword groups 318 is selected, GUI interface 310 displays exemplary keywords 510 and highlights text portions 514 of displayed document 316 near to keywords 510 are also highlighted and displayed.

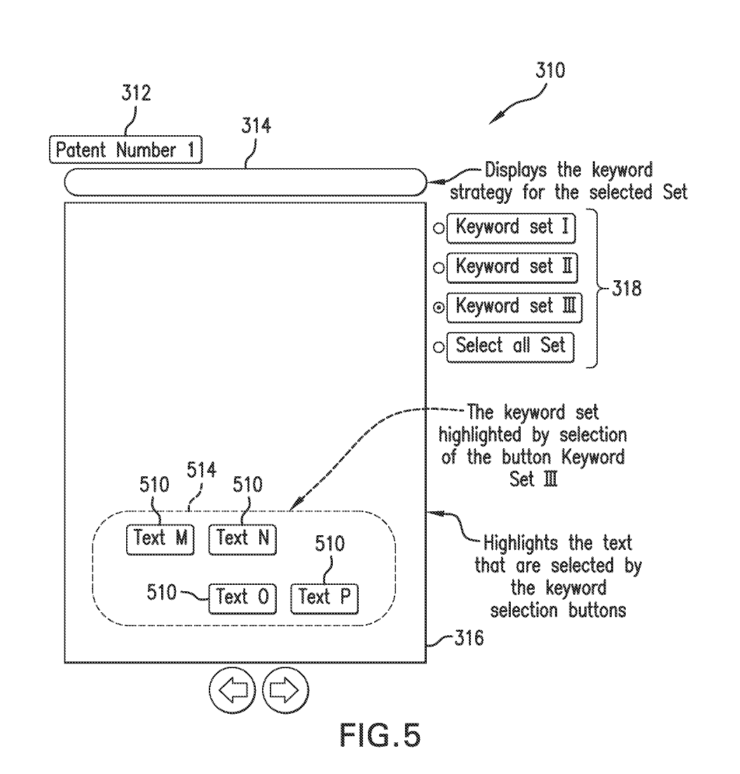

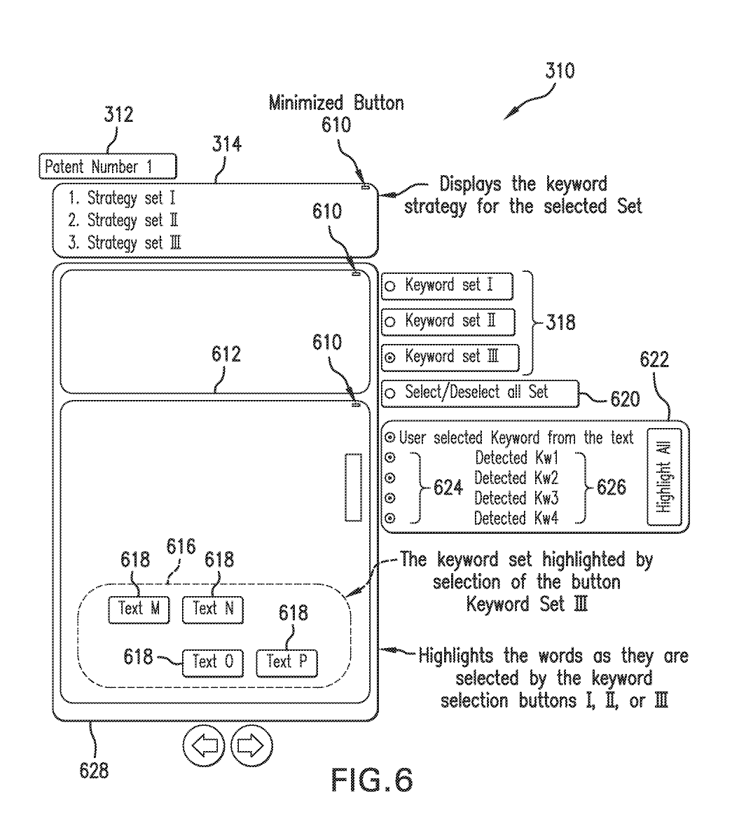

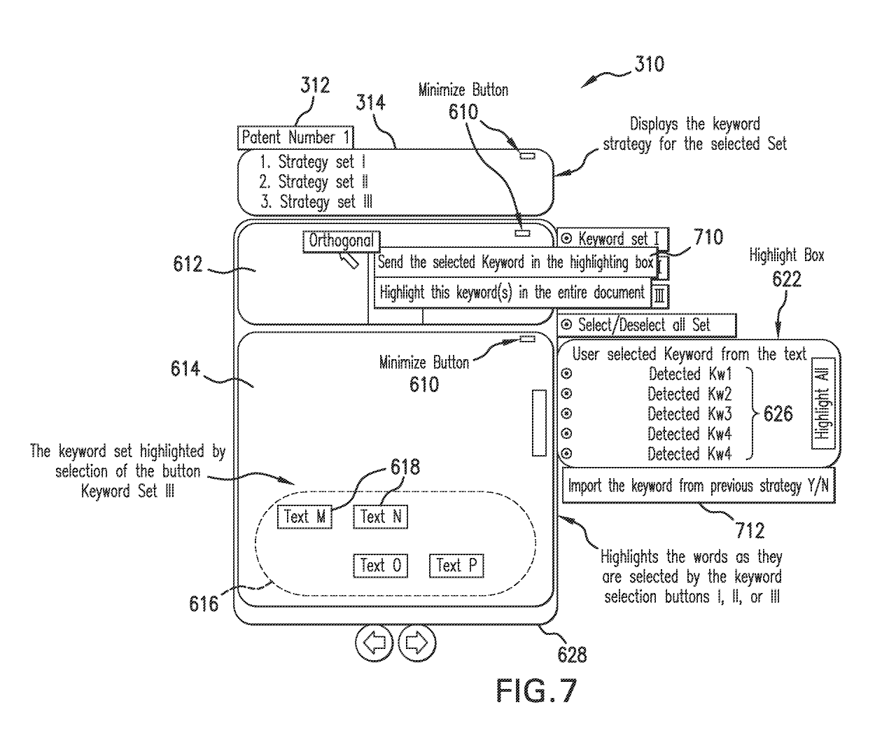

FIG. 6 illustrates a variation of the embodiments having a GUI interface 310 with a document identifier 312 and multiple windows with minimize buttons 610 and menus. In the embodiment, multiple keyword sets 318 may be selected and results displayed in window 612 with the document and surrounding text 616 displayed in window 614. In the embodiment, one or more sets of keywords 318 can be displayed to the user in window 314 by in a convenient manner. Menu item 620 provides a shortcut for selecting or de-selecting all keywords sets 318 at the same time. Window 622 displays additional keywords 626 extracted or detected by the exemplary search system. The user can select these keywords 626 using a button 624 for highlighting purpose or as illustrated in FIG. 7, a user can select a keyword in highlighting box 616 and send it 710 a from one of a categorized keyword set 318 to a different set that is representative of a particular feature of the search. An option is also provided to import a keyword from a previously saved search strategy using a menu button 712. FIG. 8 illustrates the embodiment of FIG. 7 with an additional feature of using an external file source 810 to enhance the user-defined keyword sets 318. A dictionary, synonym, encyclopedia, or other type of word or subject matter knowledge base can provide a user with choices of terms or phrases to add to each keyword set 812.

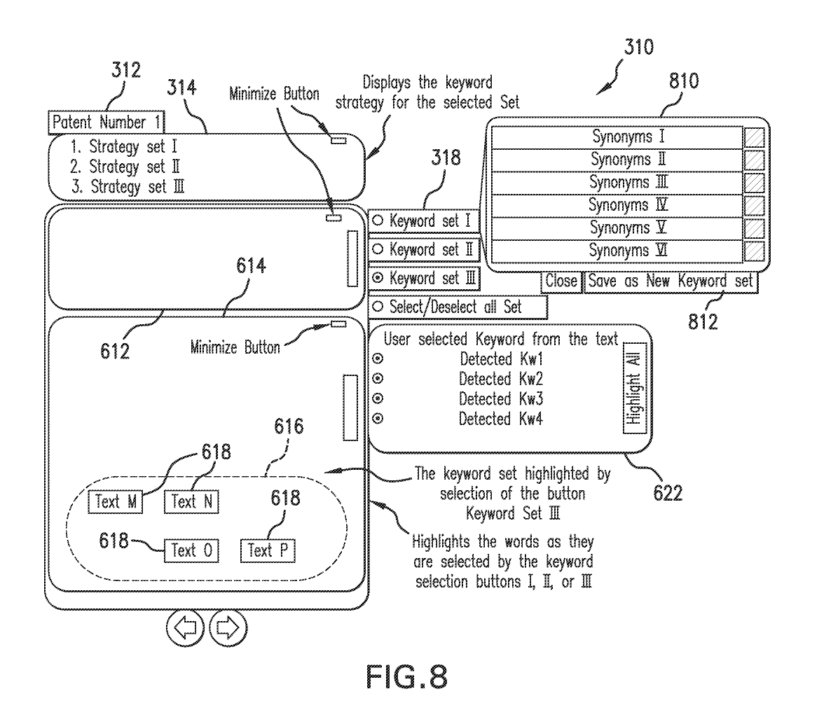

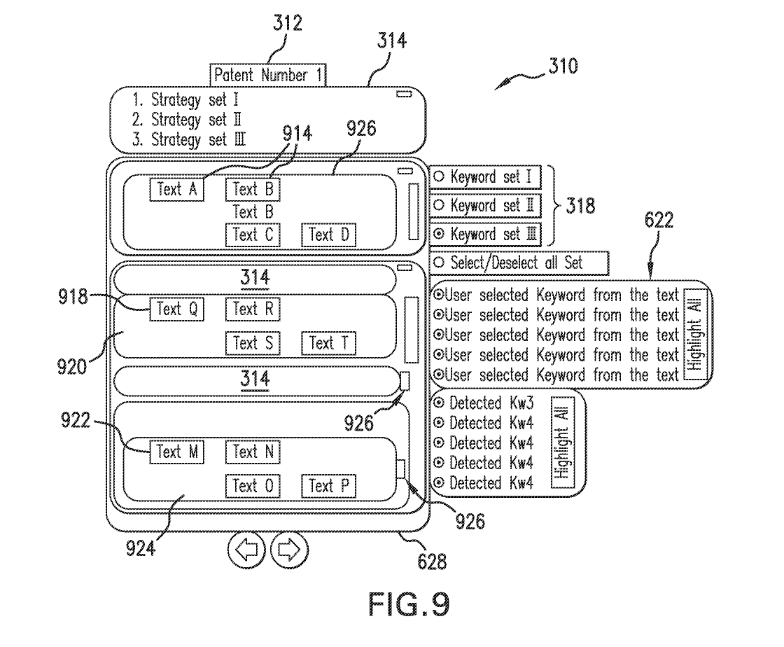

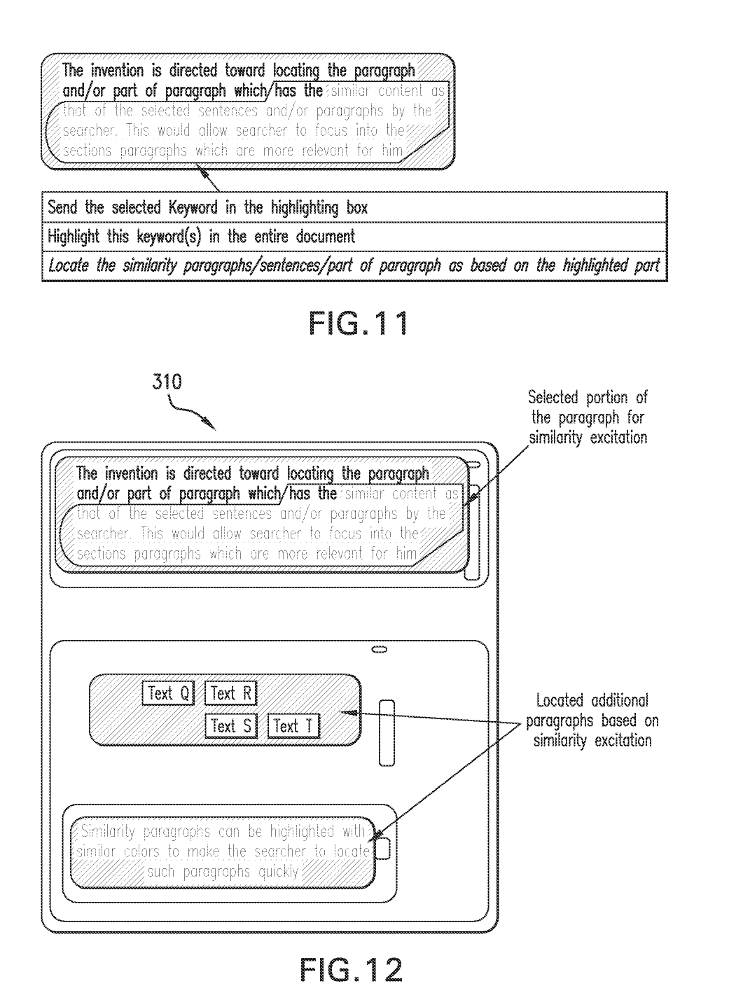

FIGS. 9 through 14 illustrate various embodiments of the invention for locating similar text within a document based on a user selection of keywords or text strings. Within GUI window 628 two viewing windows 910 and 912 are shown. In window 910 a user selects keywords 914 and/or a text string 916 from a document or selects from a pre-defined keyword sets 318. Other sets of keywords 918 and text strings 920 and keywords 922 and text strings 924 can be displayed. a user selects a first portion of the text in the patent/non-patent literature document, and in response to the user selection of the first portion of the text, the search engine automatically highlights at least a second portion of the text in the same patent/non-patent literature document wherein the first portion and the second portion of the text have closest similar contents compared to the rest of the patent/non-patent literature document. In an embodiment, the portion of the text in a patent/non-patent literature include a paragraph, or a sentence, or a phrase, or a portion of a paragraph, or a portion of a sentence. In another preferred embodiment, in response to the user selection of the first portion, the search engine automatically highlights both the first portion and the second portion with the same color or with a user preferred color scheme. In another preferred embodiment, the first portion includes highlighted keywords used by the searcher for the purpose of searching. In another embodiment, the system automatically decides the first portion based on the involvement of the keywords and their proximity relationship in the first portion and automatically highlights the second portion having a closest similar content with the first portion. In yet another embodiment, in response to the user selection of a first portion, the system automatically identifies a plurality of keywords from the selected portion and populates the identified keywords in a pop-up window. The user can select a multiple of the identified keywords from the pop-up window to allow the system to automatically highlight the second portion having a closest similar content with the first portion.

In another embodiment, the search engine provides similarity excitation buttons 926 adjacent to the paragraphs that include the search terms inputted by the user during the course of the search. The existence of the similarity excitation button would mean that there are additional paragraphs that have similar content so that the user can click the similarity excitation buttons to quickly find the additional portion/paragraphs having similar contents.

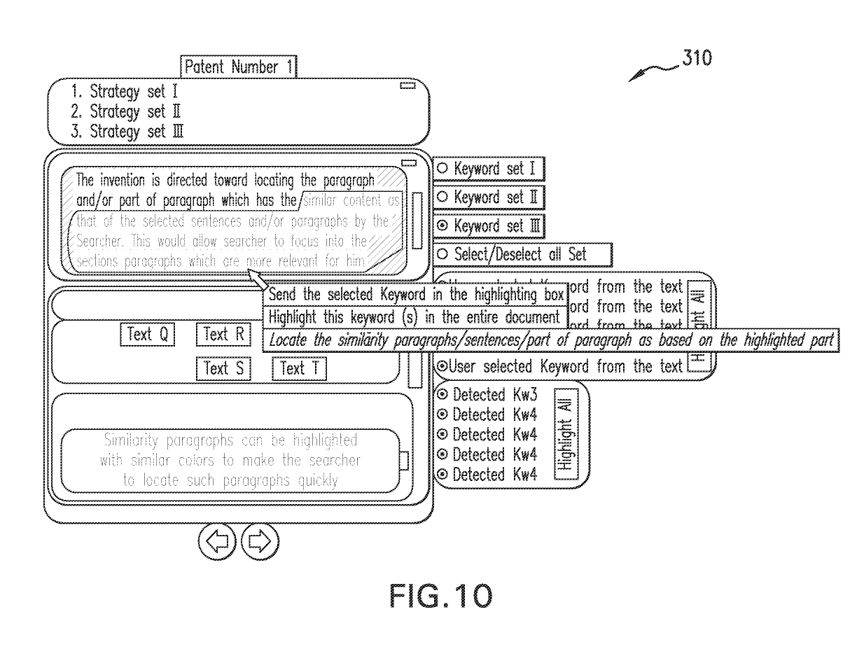

Referring specifically to FIG. 11, A user selects a portion of a text in a patent document and right clicks the mouse which results in a drop down menu where the user can select various options. In an option, the user can select a tab (see FIG. 11) for locating a similar content in the document based on his selection of the content of his interest. Upon the selection of the tab, the search engine highlights at least an another portion of the patent document having similar content. In finding a target similar content in the same document, the system first develops a correlation value among the keywords in the selected portion of the document based on proximity, frequency and relationship among various keywords. The correlation values are utilized for locating another portion of the text having similar content in the same patent document. A built in thesaurus can be utilized in locating synonyms for optimizing the correlation value.

According to one of the embodiments (e.g., described in FIGS. 9-14), the system automatically categorizes the user's search strings (having multiple strings representative of multiple features) and displays multiple keyword sets wherein each keyword set represents the individual features after the execution of the search strings through the GUI search window. Example: A user is searching for a wireless device that can detect a driver's vehicle speed and sends the speed value to a central location where it is monitored, and a warning signal is sent back to the driver.
Set I: (wireless or mobile or cellular or phone)
Set II: (detect or sense or read) <proximity operator> (velocity or speed)
Set III: (send or transfer or transmit) <proximity operator> (remote or central or distant) <proximity operator> (monitor or inspect or examine)
Set IV: (warn or alarm) <proximity operator> (driver or operator)

A final search string covers all the features that a user is investigation could be set I <and> set II <and> set III <and> set IV or, it could be any other combination of set I, set II, set III and set IV.

In response to inputting and executing this string, the program code of the system will automatically parse and analyze this final string based on keywords and their proximity relationship with other keywords and synonyms. Once the user selects one of the search results, the interface appears as shown in described in FIG. 9. What the system has done is that it has transformed the keywords of the search into categories (based on the features) which is extremely important for the users to analyze the patent efficiently. Each keyword set will have keywords (and synonyms) and proximal keywords. For each keywords set, the synonyms will be highlighted with the same color and proximal keywords will be highlighted with a different color.

According to another embodiment, the user will simply copy/paste the search (In this case the user will input the text “wireless device that can detect a driver's vehicle speed and sends the speed value to a central location where it is monitored, and a warning signal is sent back to the driver”.) features in his or her GUI search box, and the system program code will automatically analyze and parse the keywords and generate the keyword sets described above. Once the keywords sets are generated, the system allows the user to open each keyword sets and input the new keywords he wants to input or modify the set. She can further add another keyword set to represent another feature under investigation. A user can select/deselect one or more keyword sets to change a color scheme in the current document/patent opened. In response to a user selecting a keyword set, the system will automatically display the current/selected keyword string.

According to another embodiment, upon opening the search result, the system will automatically present a list of additional keywords. A user can open a particular keyword set to populate its plurality of keywords spectrum and synonyms by clicking a Keyword Set Button (for example) and drag and drop the system presented keyword into the spectrum of the keyword set.

In other embodiments, the system allows a user to select a portion of the text in the document and the inventive system will automatically rank a plurality of the paragraphs/portion of paragraphs based on the relevancy of the user selected text. In another embodiment, in response to user selecting/highlighting a portion of the text, the system will automatically bring the most relevant paragraph to the user's view with most relevant keywords highlighted with an automatically selected color or a user selected color scheme.

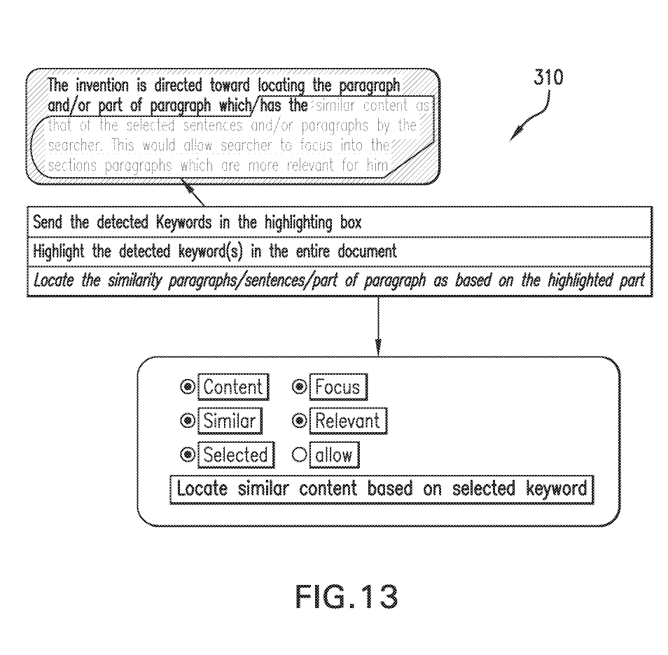

Referring an embodiment of the invention illustrated in FIG. 13, in response to the user selection of a portion of the text, the system will populate a set of keywords for the user in a new box or in a drop down menu which allows the user to select/deselect the keywords of his interest. After selecting the keywords, the user can initiate an action to locate the most relevant paragraph based on these keywords

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A computer-implemented method for facilitating review of a document, the method comprising:
processing, via a processor, a document to identify one or more portions of the document similar to a first portion of the document selected by a user; and
displaying the one or more portions of the document to the user.

2. The method of claim 1, wherein processing comprises identifying one or more keywords in the first portion of the document, determining a correlation value among the keywords based on at least one of a proximity, a frequency, and a relationship among the keywords, and identifying the one or more portions of the document similar to the first portion of the document based on the correlation value.

3. The method of claim 1, wherein processing comprises determining a document vector for the first portion of the document and identifying the one or more portions of the document similar to the first portion of the document based on the document vector.

4. The method of claim 1, wherein displaying comprises displaying the one or more portions of the document in order of their relevancy.

5. The method of claim 1, wherein displaying comprises enhancing or differentially displaying the first portion and the one or more portions of the document.

6. A system for facilitating review of a document, the system comprising:
a processor configured to process a document to identify one or more portions of the document similar to a first portion of the document selected by a user; and
a display device configured to display the one or more portions of the document to the user.

7. The system of claim 6, wherein the processor is configured to identify one or more keywords in the first portion of the document, to determine a correlation value among the keywords based on at least one of a proximity, a frequency, and a relationship among the keywords, and to identify the one or more portions of the document similar to the first portion of the document based on the correlation value.

8. The system of claim 6, wherein the processor is configured to determine a document vector for the first portion of the document, and to identify the one or more portions of the document similar to the first portion of the document based on the document vector.

9. A user interface comprising:
a viewable area comprising:
a first portion configured to display a document; and
a second portion configured to display one or more portions of the document similar to a first portion of the document selected by a user.
